(19) United States
(12) Patent Application Publication
(10) Pub. No.: US 2007/0125242 A1
(43) Pub. Date: Jun. 7, 2007

(54) Machine for the production of groups of rolls of products

(76) Inventors: Davide Dall'Omo, Bologna (IT); Matteo Pattuelli, Bagnacavallo (Ravenna) (IT)

Correspondence Address: FAY SHARPE LLP, 1100 SUPERIOR AVENUE, SEVENTH FLOOR, CLEVELAND, OH, 44114, US

(21) Appl. No.: 11/546,757

(22) Filed: Oct. 12, 2006

(30) Foreign Application Priority Data
Oct. 14, 2005 (IT) BO2005A000620

(51) Int. Cl. A23P 1/00

(52) U.S. Cl. 99/450.4

(57) ABSTRACT

A machine for the production of groups of rolls of products, each group consisting of a plurality of products grouped together to constitute a format and wrapped and closed in a sheet of film. Along a feed line the machine comprises: a first unit for transporting the groups of products one after another towards a second unit for picking up and grouping a plurality of groups of products; a first work surface with batch selection and forming means; a programmable control unit controlling the selection and forming means and the second unit, and designed to allow, immediately downstream of the second unit, relative to the feed line, formation of the batches of products depending on their type of destination downstream of the second unit.

### BACKGROUND OF THE INVENTION

The present invention relates to a machine for the production of groups of rolls of products, in particular, but without limiting the scope of the invention, for rolls of products for toilet and/or kitchen use.

It is widely known that such machines for the production of rolls consist of a plurality of stations which, along a machine extension line, divide and handle the products to form firstly the groups and then the final packs.

In practice, the stations basically consist of:
a feed unit for the rolls of products;
a unit for dividing the rolls of products into groups;
a unit for wrapping and closing the groups of products.

At this point, the production line may comprise a series of stations for transporting and positioning a plurality of said groups (called a batch—which may therefore comprise one or more of the ready wrapped groups of products) for the end of line stations in which two or more batches of products can be bagged and positioned on pallets for storage or transport.

In detail, the end of line structures of current machines may usually comprise: a 90° product diverter system (with belts and relative comb pushers); downstream of this system there is a product straightening unit (for example with a belt in a loop having radial surfaces for picking up and moving the groups of products), designed to allow the formation of batches of groups of products which are fed by other comb pushers towards a final bagging unit (normally in a direction perpendicular to batch feed on the straightening unit).

The bagging unit normally has an elevator unit or belt (to position two or more batches of products arriving one on top of another), and a subsequent station with devices for wrapping the batches placed on top of one another with outer packaging film, and relative film sealing and cutting units for forming bags.

Finally, these bags are fed towards pick up and palletizing stations by robotic handling units.

However, in some cases the manufacturer, for its own requirements, needs to palletize loose batches of products without the outer packaging bag.

In practice, in this situation first of all the bagging unit has to be disabled and, according to a predetermined logic, the products must be positioned at the straightening unit outfeed towards a surface, downstream of the bagging unit, from where the loose batches are picked up by the robotic units for layering on pallets (usually two units positioned one on either side of the surface in order to meet productivity requirements).

The following factors are required for this type of feed:
definition of the length and width of the batches, variable depending on the type of groups fed out of the straightening unit (that is to say, the format of the individual group understood as the number of products, for example 4×2, 8×2, etc.) and the consequent configurations which can be obtained on the pallets given the standard pallet measurements;
division of batches at the straightening unit outfeed into two groups relative to the central axis of the feed surface.

This division is necessary in order to define a double set of batch combinations, relative to the central feed axis, used by the robotic units during batch layering on the pallets to obtain one or more layers on the pallets according to placing in order and in sequence.

Therefore, at present to carry out such an operation the following are used:
adjustable control devices such as photocells, for defining the lengths and widths of the batches fed out of the straightening unit and
a double belt unit (above-below) for “clamping” packs of products fed out; the belts have motors designed to allow lateral movement for a calibrated movement of the batches, relative to the central axis, and their positioning along the subsequent feed surface in a sequence and a configuration predetermined by the software in the belt control unit.

A negative aspect of these construction architectures for the end of line units is the fact that, due to inherent initial design, they constrain the production machines to only one type of product outfeed (usually with outer package), and, if loose batches are selected, the bagging unit which remains upstream of the operating belts is left non-operational.

Therefore, this makes any change of end of line unit with the machine already operating, due to the manufacturer's requirements, extremely complex and expensive.

### SUMMARY OF THE INVENTION

The aim of the present invention is therefore to overcome the above-mentioned disadvantages by providing a machine for the production of groups of rolls of products having great operating flexibility and which can be used to produce both batches of products with an outer package, and loose batches of products ready for palletizing; all of this with low costs and maintaining a high level of end product reliability.

In other words, the machine for the production of groups of rolls of products according to the present invention is structured in such a way that it can be independent of the type of end of line unit to be applied downstream of the machine and such that it can form batches of products ready for packaging in bags or loose batches of products ready for palletizing.

Accordingly the present invention achieves this aim with a machine for the production of groups of products, each group consisting of a plurality of products grouped together to constitute a format and wrapped and closed in a sheet of film. Along a feed line the machine comprises: a first unit for transporting the groups of products one after another towards a second unit for picking up and grouping a plurality of groups. In addition, the machine comprises a first work surface with batch selection and forming means, positioned close to the second unit, operating on the latter and on the groups of products, and designed to allow, immediately downstream of the second unit relative to the feed line, formation of the batches, already ready, of products depending on their type of destination downstream of the second unit.

### BRIEF DESCRIPTION OF THE DRAWINGS

The technical features of the invention, in accordance with the afore-mentioned aims, are clearly indicated in the claims herein and the advantages of the invention are more evident in the detailed description which follows, with reference to the accompanying drawings, which illustrate a preferred embodiment without limiting the scope of the invention, in which:

FIGS. 1 and 2 are schematic perspective views, with some parts cut away to better illustrate others, of a machine for the production of groups of rolls of products in accordance with the present invention;

FIG. 3 is a schematic top plan view of the machine from FIGS. 1 and 2 equipped with an end of line unit;

FIG. 4 is a schematic plan view of a first alternative embodiment of the machine for the production of groups of rolls of products in accordance with the present invention;

FIG. 5 is a schematic top plan view of a second alternative embodiment of the machine for the production of groups of rolls of products from FIG. 3;

FIG. 6 is a schematic top plan view of a third alternative embodiment of the machine from FIG. 3;

FIG. 7 is a schematic top plan view of a fourth alternative embodiment of the machine, illustrated in the previous figures, for layering packs of products in boxes;

FIG. 8 is a schematic plan view of a fifth alternative embodiment of the machine illustrated in the previous figures;

FIG. 9 is a schematic plan view of a sixth alternative embodiment of the machine illustrated in the previous figures;

FIG. 10 is a schematic plan view of a seventh alternative embodiment of the machine illustrated in the previous figures;

FIG. 11 is a schematic plan view of an eighth alternative embodiment of the machine illustrated in the previous figures;

FIG. 12 is a schematic top plan view of an alternative embodiment of batch selection and forming means present on the machine illustrated in the previous figures.

### DESCRIPTION OF THE PREFERRED EMBODIMENTS

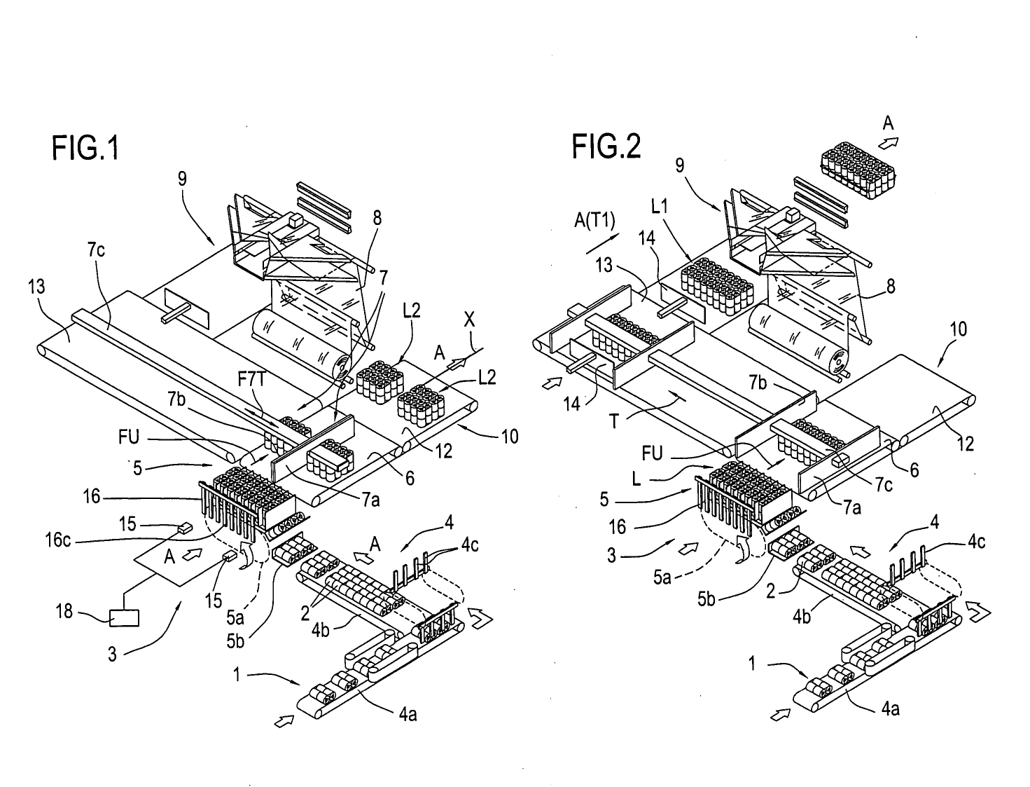

With reference to the accompanying drawings, and in particular with reference to FIGS. 1 to 4, the machine disclosed is used for the production of groups 1 of products, in particular, but without limiting the scope of the invention, for groups of rolls of products.

Each of these groups 1 consists of a plurality of products 2, grouped together to constitute a format (variable depending on production requirements), wrapped in a sheet of film and closed by means of, for example, heat-sealing.

The formation of the individual groups 1 of products is not described and illustrated in this text, since it is done by known stations and units which are not strictly part of the present invention.

The part of the machine, labeled 3 as a whole, which forms the subject matter of the present text, comprises at least, along a feed line A:
a first unit 4 for transporting the groups 1 of products one after another towards
a second unit 5 for picking up and grouping a plurality of groups 1.

These two units 4 and 5 may have various types of construction. One of these is illustrated, by way of example only, in the accompanying drawings and shown in detail in FIGS. 1 and 2. They allow the groups 1 of products to be transferred from the stations which produce the groups 1 to the end of line stations described in more detail below.

The first unit 4 may consist of a pair of belts 4a and 4b set at an angle to one another to form a system for diverting the groups 1 of products at 90°. The movement of the groups 1 of products (with two or more groups placed side by side if necessary) is achieved by a comb pusher part 4c.

Downstream of this first unit 4 there is the second unit 5, which may consist of a unit for “straightening” the groups 1 of products. This unit 5 may have, again by way of example only, a belt 5a in a loop with radial surfaces 5b for picking up and moving the groups 1 of products in the direction of rotation about its axis.

Placing two or more groups 1 of products side by side on the upper branch of the belt 5a allows a first grouping which, as will be seen, is fed by other comb pusher means or parts 16 towards the end of line units.

As FIGS. 1 to 6 clearly show, the machine 3 also comprises a first work surface 6 equipped with means 7 for selecting and forming batches L1 and L2, positioned close to the above-mentioned second unit 5.

These selection and forming means 7 and the second unit 5 are controlled by a programmable control unit 18 designed to allow, immediately downstream of the second unit 5 relative to the feed line A, formation of the batches L1 or L2 of products depending on their type of destination downstream of the second unit 5. In other words, close to the second unit 5 there are the selection means 7 for direct preparation of the batches L1 or L2 already prepared for the end of line units, such as a bagging unit 9 or a pick up station 10 for loose batches L2 of groups 1 of products to be palletized according to the choice of the manufacturer, which, depending on operating requirements, may need: batches of products already ready for outer packaging with bags, or loose batches already ready for immediate palletizing.

This embodiment of a machine 3 for the production of groups of products, therefore, allows the end user to select from a wide range of end of line configurations, since the same machine 3 can supply the batches L1 or L2 of products already ready or prepared according to the two main requirements (as already indicated, batches for bagging units and/or loose batches for immediate palletizing) of end users.

More precisely, these selection and forming means 7 for the batches L1 or L2 are controlled by the unit 18 and so are programmed to produce a first formation for preparation of the batches L1 of products already ready to be wrapped with an overwrap film 8 in a relative and subsequent, relative to the feed line A, bagging unit 9 (see FIGS. 2, 3 and 5).

Similarly, these selection and forming means 7 for the batches L1 or L2 are controlled by the unit 18 and so are programmed to produce a second formation, consisting of a set of divisions and combined positions of the batches L2 of products already ready for their loose pick up, placed in order and in sequence, in a subsequent station 10, again relative to the feed line A, and having at least one pick up unit 11 for layering the batches L2 of products on the pallet P.

This flexibility of the selection and forming means 7 allows them to generate, as already indicated, various “layouts” for the end of line stations illustrated herein, by way of example only, to confirm the validity of the machine.

FIGS. 1 to 3 illustrate a first solution for the architecture of the end of line units. In this solution, with both stations, the bagging unit 9 is positioned parallel with the second surface 12 and with the station 10 which may be equipped, for example, with robotic pick up units 11 and 11a.

In this situation, the selection and forming means 7 for the batches L1 and L2, as well as producing the first and second batch formations, also constitute the parts which move the batches L1 along a direction T transversal to the feed line A on the first surface 6, allowing the batches L1 in the first formation to be positioned close to the bagging unit 9.

The machine 3 comprises a motor-driven connecting and transport surface 13 between the first surface 6 and the bagging unit 9 in which the batches L1 can be moved by the selection and forming means 7.

The connecting surface 13 extends along the transversal direction T and at its opposite end has parts 14 for pushing the batch L1 towards the bagging unit 9 according to another direction T1 perpendicular to the above-mentioned transversal direction T.

Therefore, basically, the presence of the selection and forming means 7 for the batches L1 and L2 upstream of the end of line units allows selection of the batch formation and therefore their destination based on the type of end of line unit present and in combination with a software control program in the machine control unit 18.

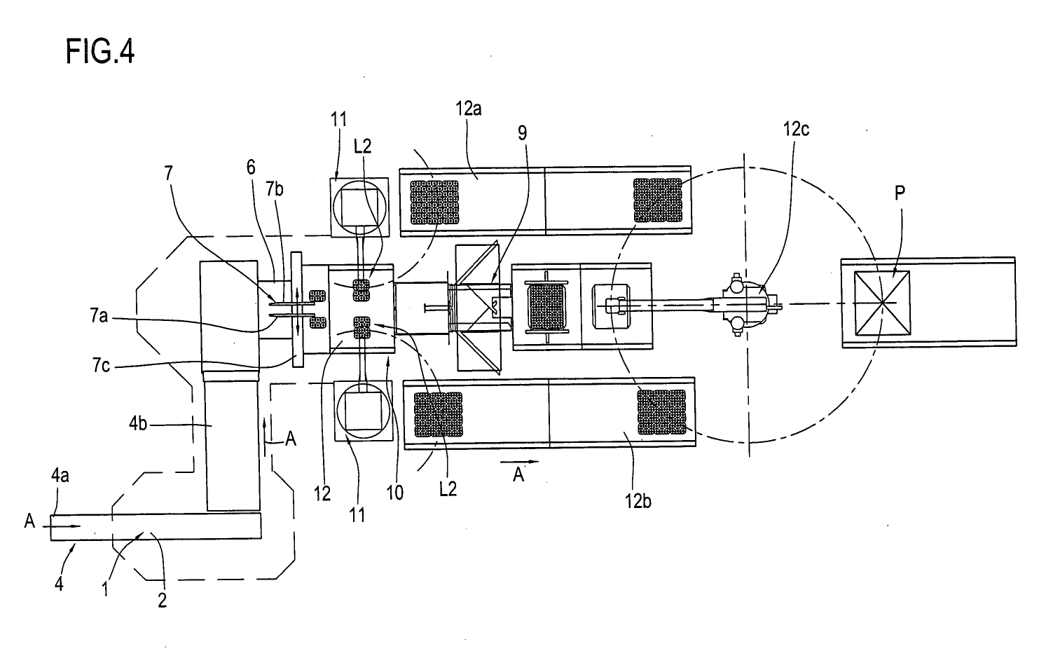

FIG. 4 shows a second solution in which the stations 10 and the bagging unit 9 are positioned along a straight feed line A and one after another. Basically, downstream of the first surface 6 with the selection and forming means 7, relative to the feed line A, there is a second surface 12 simply for the transit of the batches L1, in the first batch formation, or for pick up of the batches L2 in their second formation.

Obviously, at the side of the second surface 12 there may be at least one pick up unit 11 for the loose batches L2.

The two end of line stations, bagging unit 9 or loose batch pick up station 10 are activated, alternatively (if both are present), depending on the programming of the selection and forming means 7 for the batches L1 or L2.

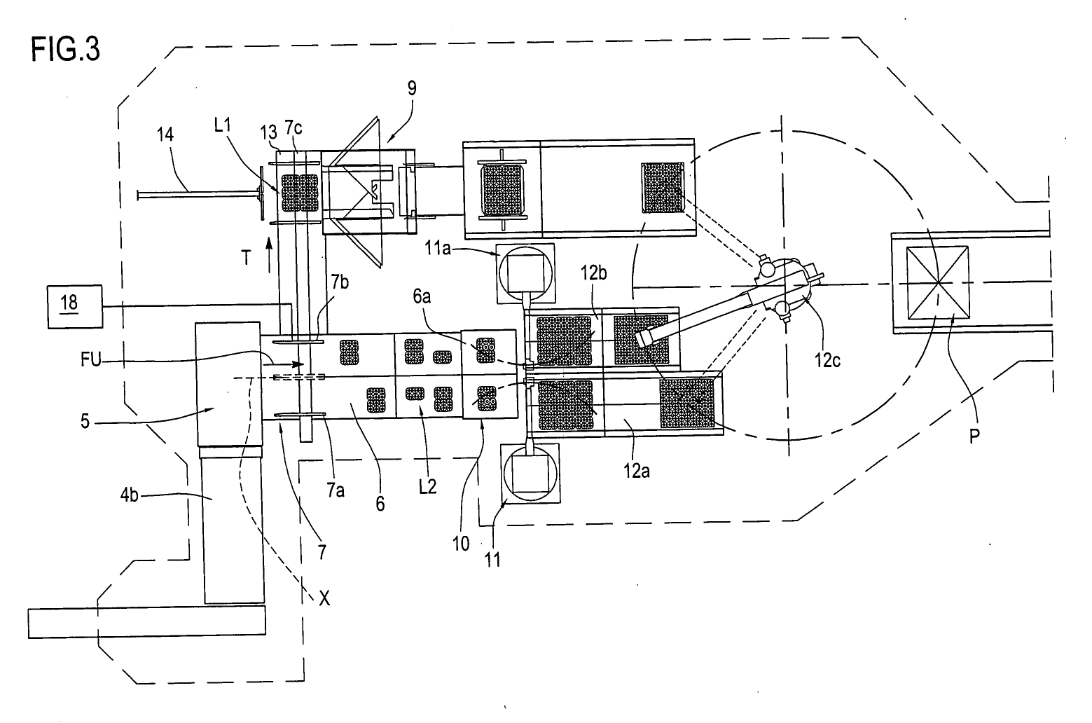

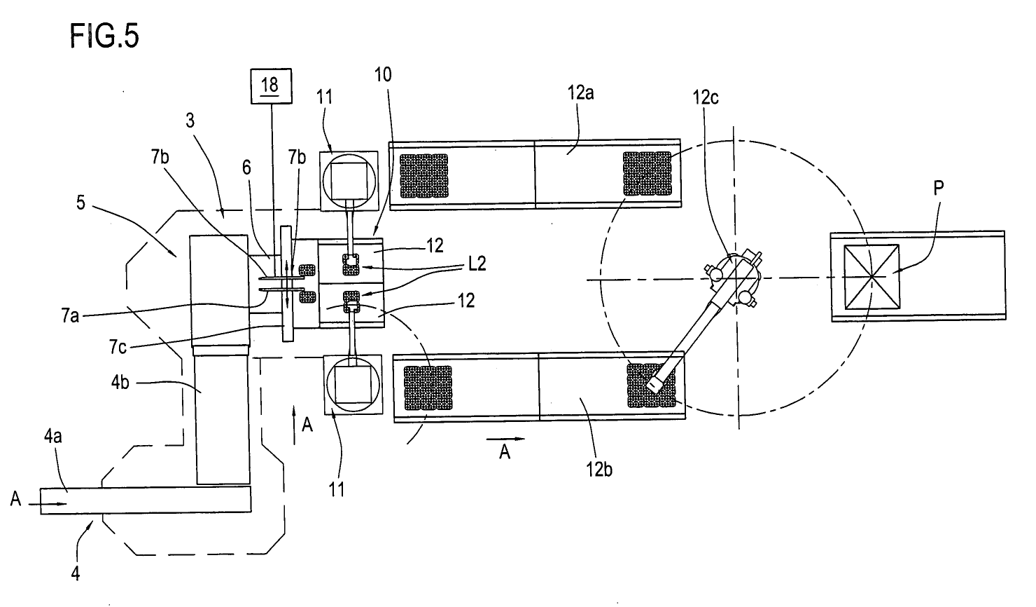

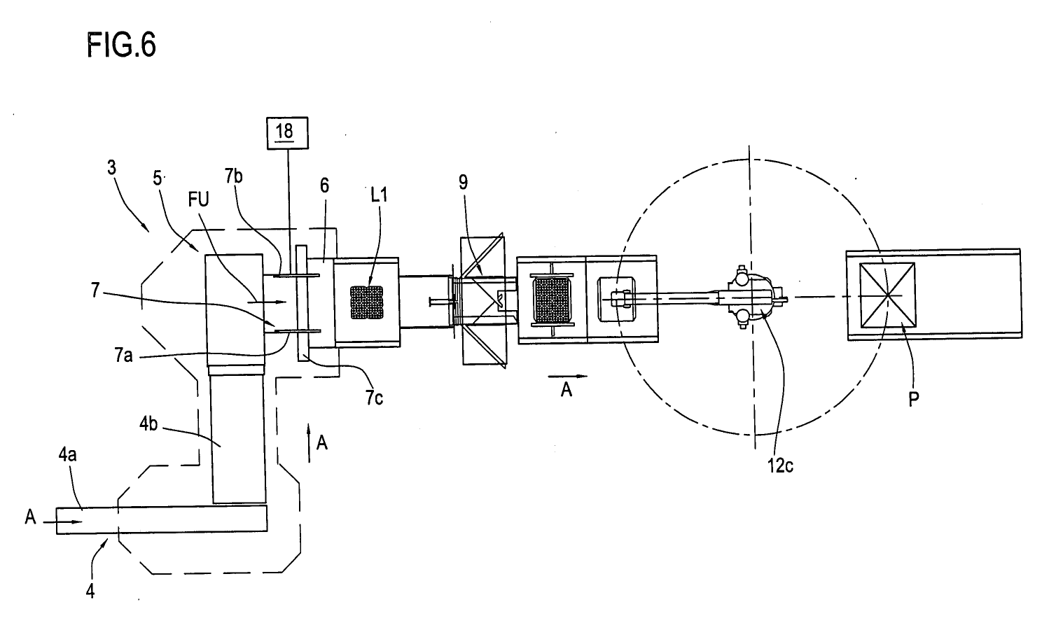

FIGS. 5 and 6 show how the presence of the selection means 7 may allow a high level of flexibility in the choice of end of line units, that is to say, a single end of line unit, loose batch pick up station 10 in FIG. 2, or bagging unit 9 in FIG. 3.

To allow relative programming of the different batches L1 or L2 to be formed, the selection and forming means 7 are controlled by the programmable control unit 18 (using special software) according to parameters defining the above-mentioned batch L1 and L2 formations (the unit 18 is illustrated as a simple block in the accompanying drawings).

In more technical detail, the selection and forming means 7 may comprise at least one pair of rigid walls 7a and 7b (developing mainly vertically), slidably supported by an upper crosspiece 7c.

The walls 7a and 7b in the pair are mobile (using known means, not illustrated) relative to one another, in both directions, according to a trajectory indicated by the arrow F7T perpendicular to the direction FU of outfeed of the grouping of groups 1 of products from the second unit 5, and in such a way as to produce the first or second formation (see FIGS. 1 and 2).

The selection and forming means 7 may also comprise, in synergy with the pair of walls 7a and 7b, sensor parts 15 connected to the control unit 18 and operating at the comb pusher parts 16 to be able to define the size (for example the length) of the batches L1 or L2 with reference to their direction of outfeed FU.

These sensor parts 15, for example a pair of position photocells or sensors, may be positioned close to the comb pusher means 16 for expelling the relative number of groups 1 of products from the second unit 5, allowing their activation when required to define part of the size of the batch L1 or L2 formation to be produced.

Obviously, the sensor parts 15 may also be adjusted along the relevant trajectories so that they can be adjusted to the various types of sizes of the batches L to be produced.

As already indicated, these sensor parts 15 may preferably be directly connected to the programmable unit 18 which, as well as being able to perform their relative adjustments, activates the pusher means 16 on the signal from the sensor parts 15.

Returning to the above-mentioned pair of walls 7a and 7b, the latter, when a first batch L1 formation is produced, are positioned at a distance from one another to give a width corresponding to the total size of the batch L1 of groups 1 of products to be wrapped with the overwrap film 8 (see FIGS. 2 and 5).

In FIGS. 1, 3 and 5, in which the pair of walls 7a and 7b is programmed to produce a second batch L2 formation, the two walls 7a, 7b define the following positions:
an initial position close to one another, allowing separation of the groups 1 of products into two separate sub-batches, on opposite sides of a center line X of the first surface 6, and
a subsequent predetermined movement away from one another by the walls 7a and 7b (see arrows F7T) to obtain batches L2 positioned in predetermined sequences (partly thanks to the sensor parts 15) destined for layering on the pallet P along the two sides of the first surface 6.

This division is used by the subsequent pick up station 10, positioned at the second surface 12, which is equipped with the pair of robotic pick up units 11 and 11a for the batch L2 of loose groups of 1 products. These two robotic units 11 and 11a are positioned on opposite sides of the second surface 12 (see FIGS. 3 and 4) and can feed relative conveyor belts 12a and 12b which, in turn, position the divided batches L2 at other units 12c for pick up and final positioning of the groups 1 of products on the pallet P.

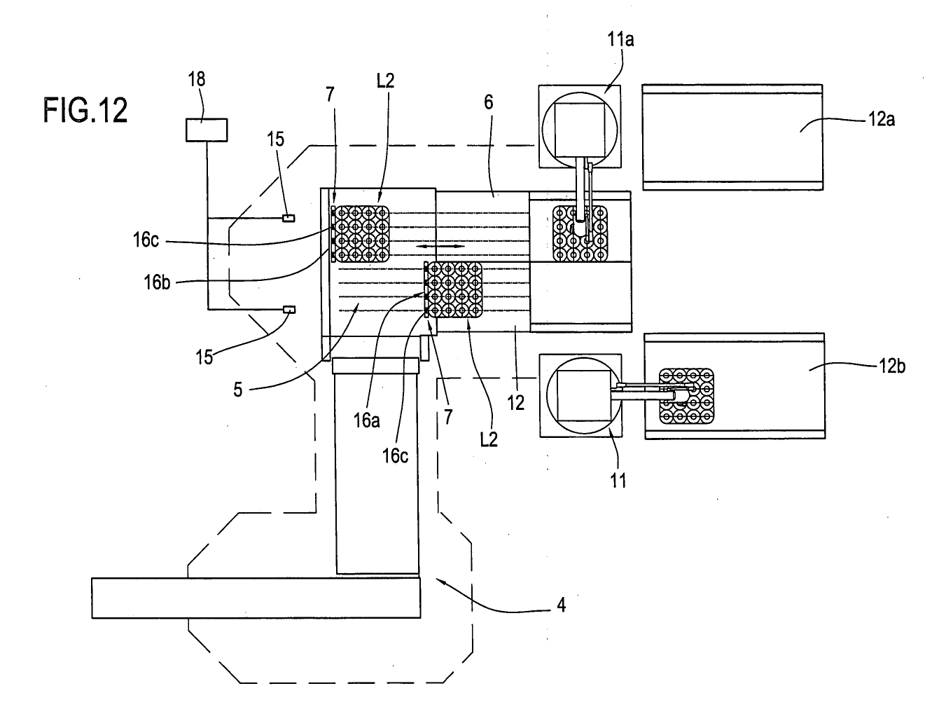

FIG. 12 shows an alternative embodiment of the selection and forming means 7.

In this case the means may be positioned on the second unit 5 and may consist directly of the pusher means 16 for the plurality of groups along the feed line A and on the first surface 6.

These pusher means 16, consisting of a plurality of pusher teeth 16c with vertical axes and mobile, in both directions, along the feed line A, may be divided into at least two sub-units 16a and 16b, controlled by the control unit 18, and designed to allow the relative feed, along the feed line A, of relative sub-groups forming the batches L1; L2 of products in a formation depending on their type of destination downstream of the second unit 5.

Further confirming the validity and elasticity of the basic configuration of the solution disclosed, FIGS. 3 and from 7 to 11 show further alternative embodiments of the end of line layouts for the machine 3 described above.

In FIG. 3, the machine 3 structure illustrated refers to the combination of the machine in FIGS. 1 and 2, with the first feed surface 6 for the groups 1 of packs of products, already divided into batches L2 according to the program provided by the unit 18 to the walls 7a and 7b, the structure having an end 6a (relative to the line A for movement of the batches L2) prepared for double pick up, that is to say on both sides, by relative robotic units 11 and 11a.

The latter units 11 and 11a position the batches L2 on another pair of belts 12a and 12b side by side and located downstream of the end 6a of the first surface 6 to form pairs of layers fed towards another, central robotic unit 12c designed to allow definitive layering on the pallet P.

Obviously, in the above-mentioned zone of the bagging unit 9, the structure remains similar to what is described above.

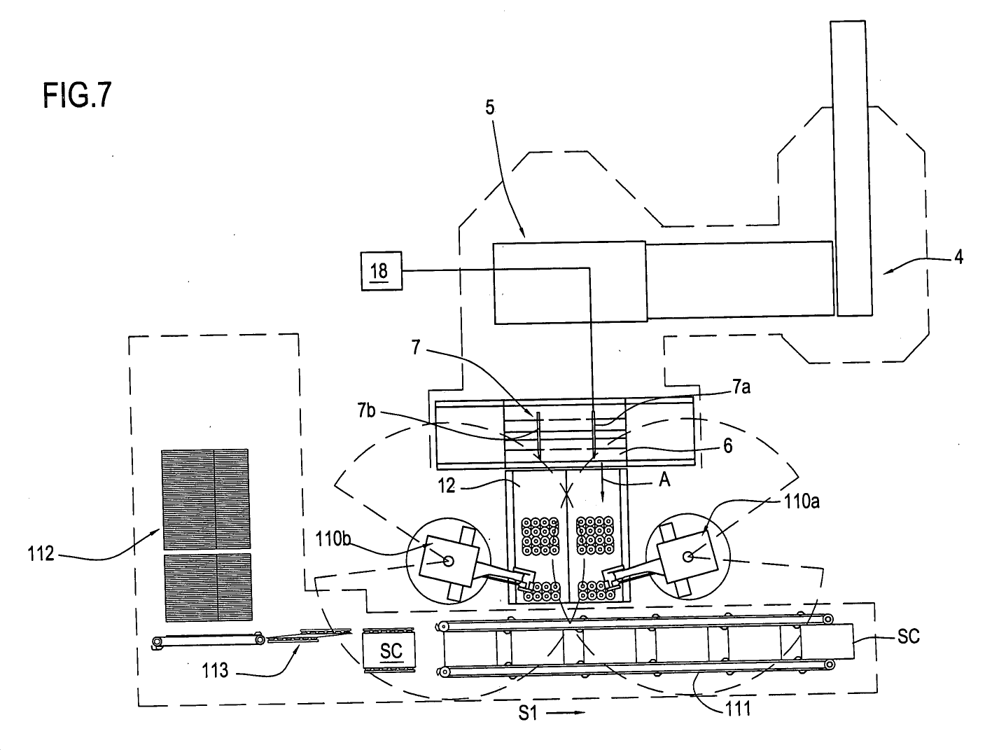

FIG. 7 illustrates another machine 3 structure which can be used for filling boxes SC (for example made of cardboard), open at the top, with the groups 1 of products arriving from the first surface 6.

Again, the machine 3 structure as far as the walls 7a and 7b remains similar to those described above. After the walls 7a and 7b there is a second double belt 12 designed to receive, from the previous first surface 6 in line with the second belt 12, the packs of loose groups 1 of products in the batch L2 configurations according to the program supplied by the control unit 18.

At the second double belt 12 there are, one on either side, two robotic units 110a and 110b for picking up the batches L2 from the relative second double belt 12 and placing them, in a suitable configuration, in the boxes SC from above.

These boxes SC are positioned, closed flat, in a suitable magazine 112 where, individually, they are prepared in a box opening or “erection” station 113.

The boxes SC are then positioned one after another and fed along a line S1, transversal to the feed line A for the batches L2, for example consisting of a pair of motor-driven belts 111 designed to allow discontinuous synchronized feed and positioning of the boxes SC one after another at the operating zone of the robotic loading units 110a and 110b.

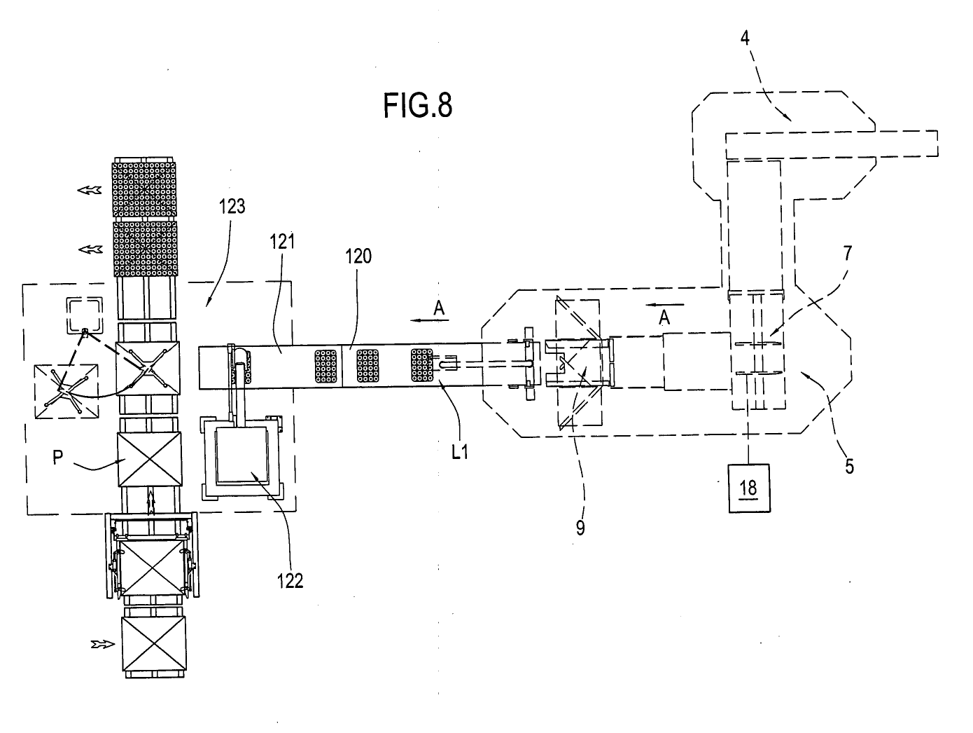

FIG. 8 shows another alternative embodiment of the construction of the end of line zone of the machine 3 previously illustrated in FIGS. 3 and 5 and having only the bagging unit 9.

Again, the machine 3 structure is similar to the previous ones as far as the walls 7a, 7b which prepare the batches L1 for wrapping and closing in the bagging unit 9.

Downstream of the bagging unit 9 there are two belts 120 and 121, positioned one after another along the feed line A and moving with different speeds, allowing the bags 1 produced to be positioned at an operating zone of a robotic pick up unit 122, programmed to layer the bags 1 on the pallet P in a relative palletizing station 123, which is described in detail in commonly owned European publication patent application No. 1 669 309 A1, corresponding to Italian patent application No. B02004A000760.

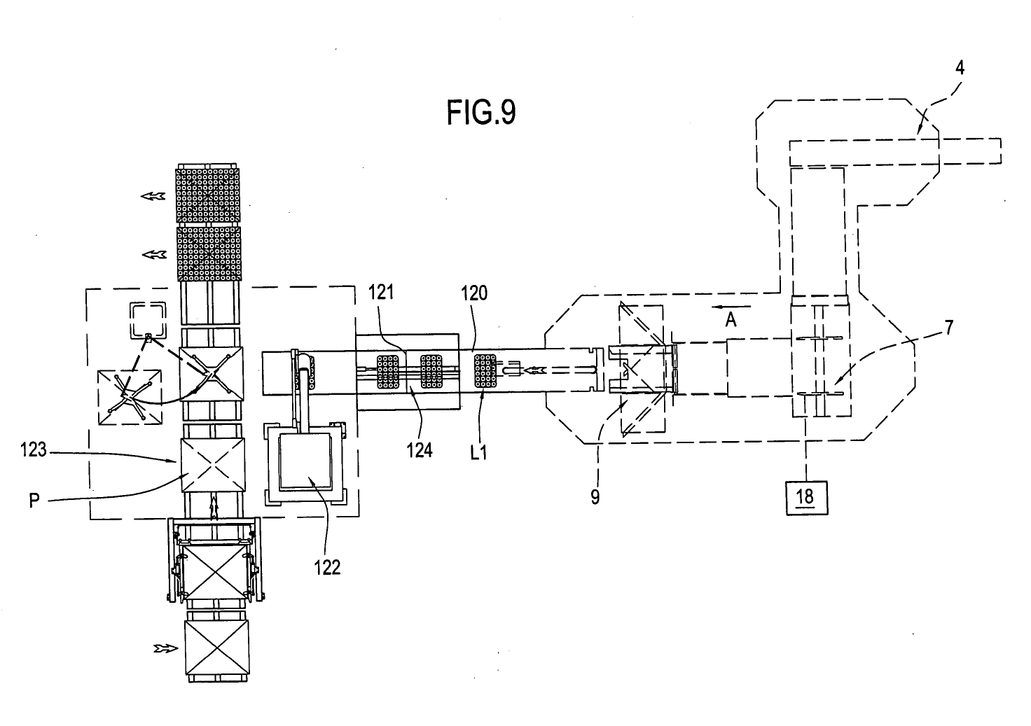

Along the lines of the previous alternative embodiment, FIG. 9 shows an alternative construction embodiment, further improved to allow higher operating speeds.

In this solution, on one of the two belts 120 and 121, there is another robotic unit 124 for positioning the bags 1 according to Cartesian axes coaxial with the second belts 120 and 121: to allow bag 1 feed according to positions and heights programmed by the unit 18 in the format required for the robotic pick up unit 122, so that the latter can pick up (on four sides) even one completed layer of bags 1 to be positioned directly on the pallet P in the relative station 123.

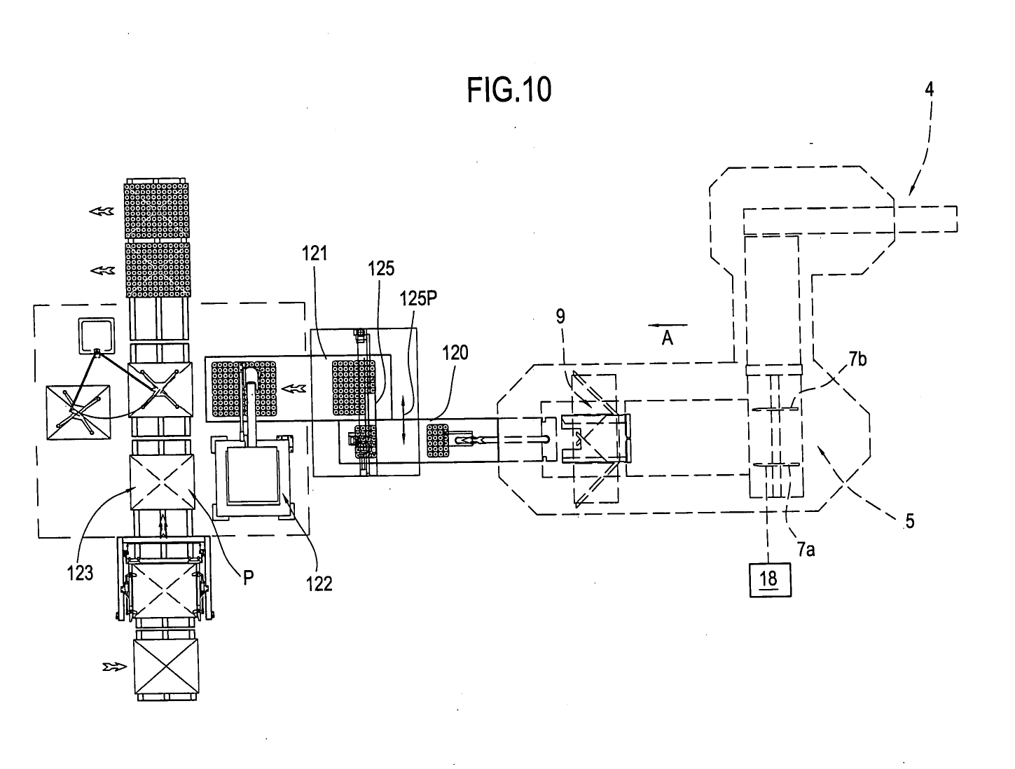

FIG. 10 shows another alternative construction embodiment based on the configurations in FIG. 9. In this situation, from the single outfeed line for the bags 1 from the bagging unit 9 on one of the belts 120 in the direction of feed A, the bags 1 are handled by a robotic unit 125 with Cartesian axes according to a movement 125P perpendicular to the direction of feed A.

In this way the bags 1 are positioned on the other belt 121, at the side of and parallel with the belt 120, to form a layer of groups 1 of products to be palletized directly on the belt 121.

When the layer is complete, the belt 121 transports the layer of groups 1 of products to the operating zone of the robotic pick up unit 122, allowing the latter to pick up (on four sides) the completed layer of bags 1 to be positioned directly on the pallet P of the station 123 using known palletizing methods.

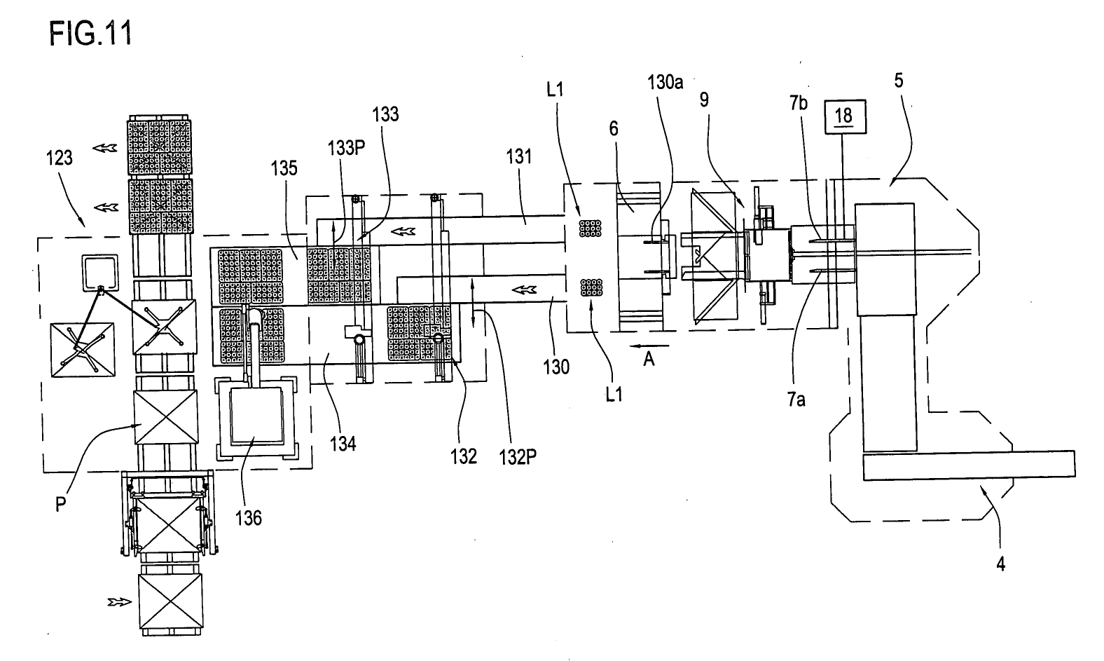

FIG. 11 shows an enhanced solution of the concept illustrated in FIG. 10 (for example for machines with high production rates in the unit of time) if the bagging unit 9 is present with batches L1.

In this solution there are two separate belts 130 and 131 for expelling from the bagging unit 9, having a unit 130a designed to direct the bags 1, alternately, onto the belts 130 and 131.

These two parallel belts 130 and 131 transport the batches L1 (in the direction of feed A) close to robotic units 132 and 133 with Cartesian axes designed to handle the batches according to relative movements 132P and 133P perpendicular to the direction of feed A.

In this way the bags 1 of products are positioned on a respective belt 134 and 135, by the side of and parallel with the corresponding belt 132 and 133, already forming a relative layer of bags 1 of products to be palletized.

When the layer is complete, the belts 134 and 135 transport the layer of bags 1 of products to the operating zone of the robotic pick up unit 136, allowing the latter to pick up (on four sides) the completed layer of bags 1 to be positioned directly on the pallets P (even several simultaneously) using known palletizing methods.

The machine structured in this way therefore fulfils the preset aims, thanks to the possibility of supplying the end user with a machine structure irrespective of the end of line unit selected by the user, since the machine is able to prepare both batches of products for bagging units and batches already ready to be immediately palletized.

This is done by structuring the machine with batch selection and forming means positioned upstream of the end of line units (bagging units and/or loose product pick up units).

The possibility of having the selection and forming means already present in the machine significantly facilitates the choice and configuration of the end of line units by the user, in addition to the fact that, even afterwards, the same user may, if necessary, add units to a machine which is already operating without rendering the unit already present “obsolete”.

The invention described has evident industrial applications and may be modified and adapted without thereby departing from the scope of the inventive concept. Moreover, all details of the invention may be substituted by technically equivalent elements.

1) A machine for the production of groups of products, each group comprising a plurality of products grouped together to constitute a format and wrapped and closed in a sheet of wrapping film; the machine comprising, along a feed line:
a first unit for transporting the groups of products one after another towards;
a second unit for grouping a plurality of groups
a first work surface with batch selection and forming means;
a programmable control unit, which controls the selection and forming means and the second unit, being designed to allow, immediately downstream of the second unit relative to the feed line, formation of the batches of products depending on their type of destination downstream of the second unit.

2) The machine according to claim 1, wherein the selection and forming means for the batches are programmed by the control unit to produce a first formation for preparation of the batches of products to be wrapped with an overwrap film in a relative and subsequent, relative to the feed line, bagging unit.

3) The machine according to claim 1, wherein the selection and forming means for the batches are programmed by the control unit to produce a second formation, comprising a set of divisions and combined positions of the batches of products designed to allow their loose pick up, placed in order and in sequence, in a subsequent station, relative to the feed line, and having at least one pick up unit for layering the batches of products on the pallet.

4) The machine according to claim 1, wherein the selection and forming means for the batches are programmed by the unit to produce, respectively:
a first formation for preparation of the batches of products to be wrapped with an overwrap film in a relative and subsequent, relative to the feed line, bagging unit; or
a second formation, comprising a set of divisions and combined positions of the batches of products designed to allow their loose pick up, placed in order and in sequence, in a subsequent station, relative to the feed line, and having at least one pick up unit for layering the batches of products on the pallet.

5) The machine according to claim 1, wherein downstream of the first surface with the selection and forming means, relative to the feed line, there is a second surface for the transit of the batches in the first batch formation, or for pick up of the batches in the second formation; there being at least one pick up unit at the side of the second surface.

6) The machine according to claim 5, wherein downstream of the second transit or pick up surface, relative to the feed line, there is a bagging unit which can be activated in the presence of one of the first formations for preparation of the batches.

7) The machine according to claim 3, wherein the bagging unit is positioned parallel with the station which has at least one pick up unit and in that the selection and forming means for the batches also constitute parts for moving the batches along a direction transversal to the feed line on the first surface, allowing said batches in the first formation to be positioned close to the bagging unit.

8) The machine according to claim 7, comprising a motor-driven connecting and transport surface between the first surface and the bagging unit in which the batches can be moved by the selection and forming means; the connecting surface extending along the transversal direction and at its opposite end having parts for pushing the batch towards the bagging unit according to another direction perpendicular to said transversal direction.

9) The machine according to claim 1, wherein the selection and forming means comprise at least one pair of rigid walls, slidably supported by an upper crosspiece, and mobile relative to one another, in both directions, according to a trajectory perpendicular to the direction of outfeed of the batches from the second unit, and in such a way as to produce the first or second formation.

10) The machine according to claim 1, wherein the selection and forming means comprise sensors parts for defining a batch size, located close to and acting from/on pusher means for expelling the relative number of groups of products from the second unit, allowing their activation when required.

11) The machine according to claim 9, wherein when a first batch formation is produced, each of the walls is distanced from the other to give a width corresponding to the total size of the batch of groups of products to be wrapped with the overwrap film.

12) The machine according to claim 9, wherein when a second batch formation is produced, the two walls comprise the following positions:
an initial position with the two walls close to one another, allowing separation of the groups of products into two separate sub-batches, on opposite sides of a center line of the first surface, and
a subsequent predetermined movement away from one another by the walls so that said sub-batches are positioned in predetermined sequences, determined by a control unit, and destined for layering on the pallet along the two sides of the second surface.

13) The machine according to claim 9, wherein the selection and forming means are controlled by the programmable control unit according to parameters producing the batch formations.

14) The machine according to claim 1, wherein the selection and forming means are positioned on the second unit and comprise means for pushing the plurality of groups along the feed line and on the first surface; the pusher means being divided into at least two sub-units controlled by the control unit and designed to allow the relative feed, along the feed line, of relative sub-groups forming the batches of products according to a formation depending on their type of destination downstream of the second unit.

15) The machine according to claim 3, wherein the pick up station positioned at the second surface is equipped with a pair of robotic units for picking up the batches of groups of products, the robotic units being positioned on opposite sides of the second surface.

16) The machine according to claims 1 and 3 claim 1, wherein the first feed surface for the groups of packs of products, divided into batches according to the program provided by the unit to the selection and forming means, has an end, relative to the movement line, prepared for double pick up, that is to say on both sides, by relative robotic units; said units being designed to position the batches on another pair of belts side by side and located downstream of the end of the first surface, forming pairs of layers fed towards another, central robotic unit designed to allow definitive layering on the pallet.

17) The machine according to claim 1, comprising, after the first surface, a second double belt or surface designed to receive, from the previous first surface, in line with the second belt, the loose packs of groups of products in the batch configurations according to a predetermined control unit program; at the second double belt there being, one on either side, two robotic units for picking up the batches from the relative second double belt and placing them from above, in a suitable configuration, in boxes open at the top; the boxes being positioned one after another along a line transversal to the feed line for the batches, comprising a synchronized movement station.

18) The machine according to claim 2, comprising, downstream of the bagging unit, two belts, positioned one after another along the feed line and moving with different speeds, allowing the bags produced to be positioned at an operating zone of a robotic pick up unit; the robotic unit being programmed to layer the bags on the pallet in a relative palletizing station.

19) The machine according to claim 2, comprising, downstream of the bagging unit, two belts, positioned one after another along the feed line and designed to allow the bags produced to be positioned at another robotic unit for positioning the bags according to Cartesian axes coaxial with the second belts; the robotic unit being designed to allow bag feed according to positions and heights programmed by the unit in the format required for a robotic pick up unit to allow the latter to pick up even one complete layer of bags to be positioned directly on the pallet.

20) The machine according to claim 2, comprising, downstream of the bagging unit, a belt designed to allow the bags produced to be positioned, along the feed line, at a robotic unit with Cartesian axes acting on the bags according to a movement perpendicular to the feed line, and so as to position the bags at another belt, located at the side of and parallel with the belt, to form a layer of groups of products to be palletized directly on the belt; the latter belt being designed to transport the completed layer of groups of products to the operating zone of a robotic pick up unit.

21) The machine according to claim 2, comprising, downstream of the bagging unit, two separate, parallel belts for expelling the bags, the latter being positioned, alternately, on the belts by a positioning unit; the two belts moving the bags, according to the feed line, close to robotic units with Cartesian axes designed to handle the bags according to movements perpendicular to the feed line; the robotic units being designed to position the bags on a respective belt, by the side of and parallel with the corresponding belt, forming a relative layer of bags of products to be palletized.
